(19) United States
(12) Patent Application Publication
(10) Pub. No.: US 2006/0190928 A1
(43) Pub. Date: Aug. 24, 2006

(54) Device and method for managing communication equipment

(75) Inventors: Sung-Tae Kim, Suwon-si (KR); Jeong-Ho Cha, Suwon-si (KR); Tae-Sung Park, Yongin-si (KR)

Correspondence Address: CHA & REITER, LLC, 210 ROUTE 4 EAST STE 103, PARAMUS, NJ, 07652, US

(73) Assignee: Samsung Electronics Co.; LTD

(21) Appl. No.: 11/154,627

(22) Filed: Jun. 16, 2005

(30) Foreign Application Priority Data
Feb. 4, 2005 (KR) 2005-10811

(51) Int. Cl. G06F 9/44

(52) U.S. Cl. 717/121; 709/223

(57) ABSTRACT

The present invention relates to a device and method for managing a communication equipment, such as a router or a switch, using a command-line interface (CLI). A managing unit managing the communication equipment stores management information, which is a newly added software module or command, in a string format in a management file storage, and the management information is parsed in a parser and a newly registered management information is added to a database, thereby registering new management information without the need of compiling a CLI agent.

### CLAIM OF PRIORITY

This application claims priority under 35 U.S.C. § 119 to an application entitled “Device and Method for Managing Communication Equipment,” filed in the Korean Intellectual Property Office on Feb. 4, 2005 and assigned Serial No. 2005-10811, the contents of which are incorporated herein by reference.

### BACKGROUND OF THE INVENTION

1. Field of the Invention

The present invention relates generally to a device and method for managing a communication equipment, such as a router or a switch. More specifically, the present invention relates to a device and method for managing the communication equipment using a command-line interface (CLI).

2. Description of the Related Art

In general, a communication equipment such as a router or a switch serves as a middle node for transmitting data or a specific control signal in a wire network. In particular, the communication equipment serves to determine a telecommunication line and sets a path to a destination node. Thus, it is essential that the communication equipment always perform an accurate operation. However, the communication equipment fails to perform accurately during a self-program mode or when they are updated occasionally. When an operator manages the communication equipment using a console, he/she typically uses an interface. A typical interface is a command-line interface (CLI). The command-line interface (CLI) and other user-developed interfaces are provided for accepting commands, displaying communications and providing results. The operator inputs a command to a CLI agent through the console using a managing unit in order to execute a desired program, manage a software module, and provide file, database, block, or other types of data access services.

As an Internet protocol (IP) plays a major role in a network environment, software modules sought by a third party and an equipment manager are typically installed in the communication equipment. In order to allow the managing unit to manage the software modules, the CLI agent must perform a direct communication with the software modules, and the CLI agent and the software modules must communicate with each other using the CLI. In this case, L2 or L3 protocol is typically used. Accordingly, the CLI agent creates each of the software modules and the CLI to communicate with each of the software modules and manages a CLI command.

However, when it is necessary for the operator to add or update a specific software module, the CLI agent may require a communication between the operator and the communication equipment using a specific newly added or updated software. Therefore, whenever each of the software modules or the commands is changed, the CLI agent must manage the changed software modules or commands. Accordingly, the CLI agent must revise or compile a corresponding code of the updated software, or must compile the newly added software and retain compiled data. That is, whenever a new CLI command is added, the CLI agent always need to compile the newly added CLI command. Due to a frequent compilation of the CLI agent, there is a drawback of increasing a total search time which in turn raises the cost related to searching.

### SUMMARY OF THE INVENTION

The present invention provides a device and method for managing a communication equipment using a command-line interface (CLI). The present invention is applicable to storage area networks having a high-speed sub-network of shared storage devices on a local area network (LAN), wide area network (WAN), or other networks.

According to one aspect of the present invention, there is provided a device for managing a communication equipment using a CLI (command-line interface) agent. The device includes: a management file storage for receiving and storing management information defined by a managing unit, which manages the communication equipment; and the CLI agent for parsing the management information from the management file storage to determine whether or not the parsed management information has newly registered information and store the newly registered information, when the communication equipment is initially activated. The CLI agent is configured to allocate a socket port for a newly registered software module and an IPC (inter process communication).

According to another aspect of the present invention, there is provided a method of managing a communication equipment using a CLI (command-line interface) agent. This method includes: storing management information for managing the communication equipment by a managing unit; when the communication equipment is initially activated, parsing the management information and determining whether or not the parsed management information has newly registered management information by a command register; and storing the newly registered management information in a database by the command register.

### BRIEF DESCRIPTION OF THE DRAWINGS

The above features and advantages of the present invention will become more apparent from the following detailed description when taken in conjunction with the accompanying drawings in which:

FIG. 1 is a view illustrating a construction of a system for managing a communication equipment according to an embodiment of the present invention; and

FIG. 2 is a flowchart illustrating a method for managing a communication equipment according to an embodiment of the present invention.

### DETAILED DESCRIPTION

An embodiment of the present invention will now be described in detail with reference to the annexed drawings. For the purposes of clarity and simplicity, a detailed description of known functions and configurations incorporated herein has been omitted for conciseness.

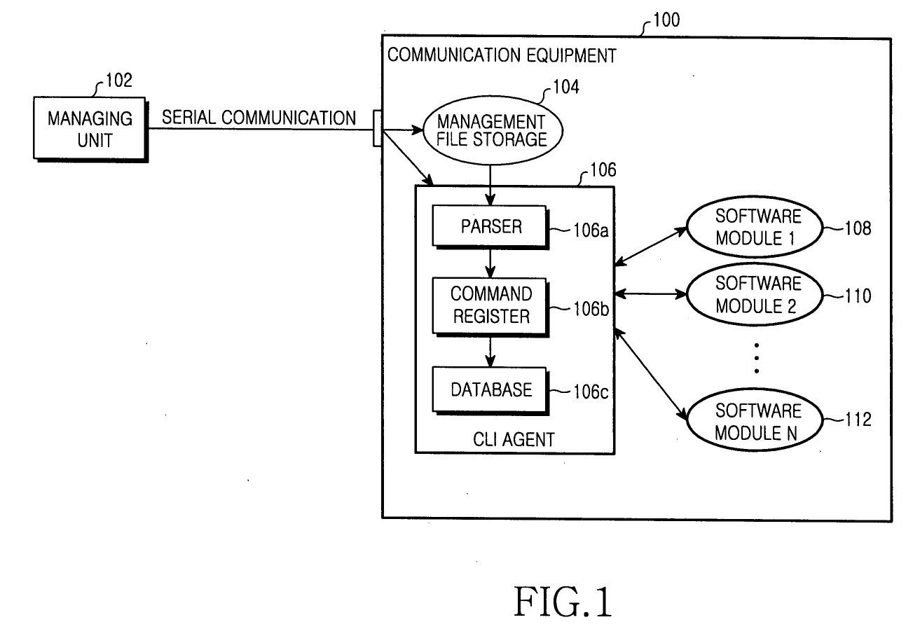

FIG. 1 shows the construction of a system for managing a communication equipment according to an embodiment of the present invention. In FIG. 1, it is assumed that a manager communicates with a specific communication node (that is, a switch, a router, or a hub) using a console. The switch may be an Ethernet switch, fast-Ethernet switch, or another type of switching device known to persons skilled in the relevant art(s). The switch may be replaced by a router or a hub. A router generally moves data from one local segment to another, and to the telecommunications carrier for remote sites. A hub is a common connection point for devices in a network. Suitable hubs include passive hubs, intelligent hubs, and switching hubs, and other hub types known to persons skilled in the relevant art(s). Note that a peripheral environment or other constituent elements of the communication node are not shown in FIG. 1 as they are well know to those skilled in the art. Further, it should be noted that the system according to the embodiment of the present invention may include a variety of devices which support communication between many different entities and also supports many different types of communication links implemented in a variety of architectures.

As shown, the inventive managing system includes a communication equipment 100 such as the switch or the router and a managing unit 102. The communication equipment 100 includes the software modules 108, 110, . . . , and 112 for enabling its specific operation. The managing unit 102 manages software modules 108, 110, . . . , and 112 of the communication equipment 100 or their modifications using the internal console. The managing unit 102 creates a command-line interface (CLI) using a CLI agent 106 to each of the software modules 108, 110, . . . , and 112. Thus, the managing unit 102 manages the software modules 108, 110, . . . , and 112 using a CLI command. The managing unit 102 and the CLI agent 106 can establish a serial communication or a TELNET, for example. The CLI agent 106 creates the CLI to perform an inter process communication (IPC) with each of the software modules 108, 110, . . . , and 112.

The communication equipment 100 includes a management file storage 104 for storing management information, such as information constituting the CLI command to allow the managing unit 102 to manage the communication equipment 100 using the CLI command. The management information refers to the software module, a command, a command mode, a help, and the like that constitute newly added execution files. The management information is stored in a string format in the management file storage 104 and controls each of the software modules 108, 110, . . . , and 112 through the CLI agent 106.

In the specification, a mode refers to a group of the same-featured commands based on a manager's privilege on the communication equipment 100, a command content, and characteristic. The manager's privilege is classified into two types: one is a privilege for only inquiring a setup command content, and the other one is a privilege for setting up the command content. For example, the follows are exemplary files in which command information is arranged in the string format.

EXEC_MODE test “show test version” “show running system information” “TEST daemon” “Version”

TEST_MODE test “test set <1-65535>” “TEST daemon” “set” “Range” The file includes information on “show test who” (command inquiring a version of a software module of—test) and “test set <1-65535>” (command setting-up a predetermined number of 1 to 65535 to the software module of—test).

The EXEC_MODE and the TEST_MODE are command modes, and the “test” refers to the software module. That is, the commands are executed in the software module of “test.”

The commands “show test who” and “test set <1-65535>” are executed in the software module of “test.” Here, the “show test who” and the “test set <1-65535>” are the command and a parameter, and remaining sentences cited in “ ” refer to help strings for describing the commands, respectively.

More specifically, the EXEC_MODE refers to the group of the commands that can be executed by all the managers and can inquire the setup command content irrespective of the manager's privilege. The TEST_MODE refers to the group of the commands executed in the software module of “test.” Only the manager having a setup privilege can execute the command of the TEST_MODE.

Referring back to FIG. 1, the CLI agent 106 is comprised of a parser 106a, a command register 106b, and a database 106c according to an embodiment of the present invention.

In operation, the parser 106a extracts and sorts only necessary management information from the management information stored in the string format in the management file storage 104. The command register 106b compares the sorted management information with management information stored in the database 106c and determines whether or not the sorted management information is newly added or registered management information. In case where it is determined that the sorted management information is the newly added or registered management information, the newly added or registered management information is stored in the database 106c. The database 106c stores and registers the newly registered management information in a global structure stored in the database 106c.

In case where the communication equipment 100 is activated, and the command register 106b determines that there is a newly registered software module, the CLI agent 106 creates a socket port for performing communication using the newly registered software module and the IPC (inter process communication).

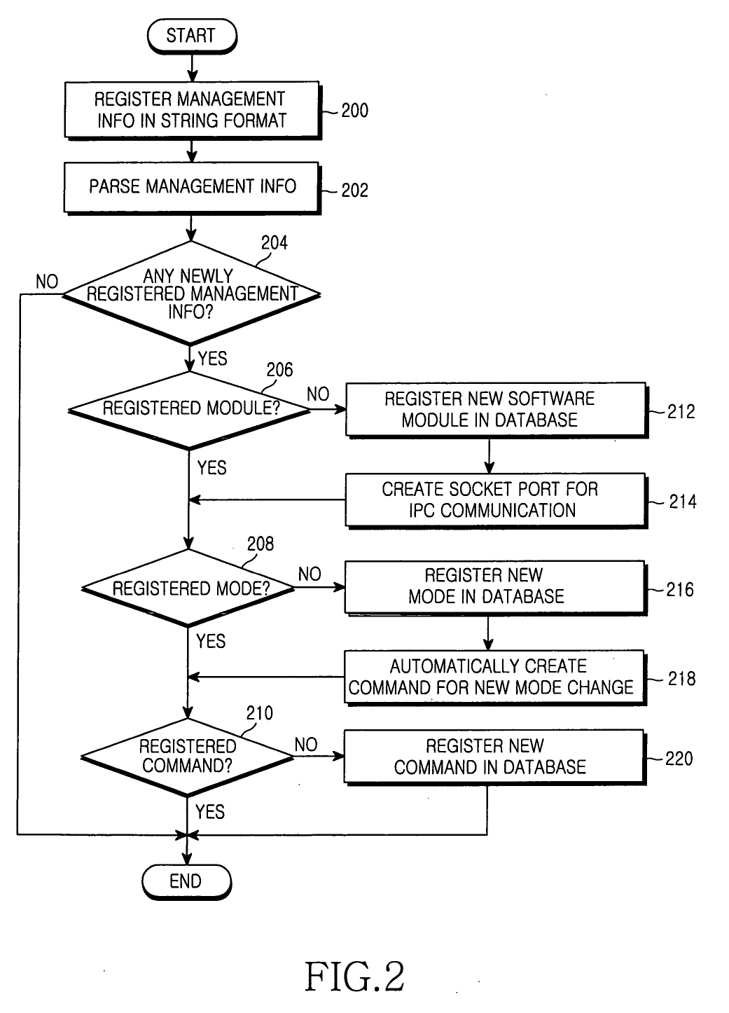

FIG. 2 is a flowchart illustrating a method of managing the communication equipment according to an embodiment of the present invention.

In Step 200, the managing unit 102 stores the management information for managing the communication equipment 100 in a string format in the management file storage 104 through the console. In Step 202, the parser 106a of the CLI agent 106 parses the stored management information, and extracts and sorts only necessary management information from the stored management information. When the CLI agent 106 is initially activated or is reactivated, the parser 106a parses the management information stored in the management file storage 104.

In Step 204, the command register 106b determines whether or not the parsed management information has a newly registered management information. If so, it is further determined whether or not the newly registered management information is a software module stored in the database 106c in Step 206. If the command register 106b determines that the parsed management information does not have the newly registered management information in the Step 204, a procedure is ended.

If it is determined that the newly registered software module is not the software module stored in the database 106c in the Step 206, the command register 106b registers a name of the newly registered software module in the database 106c in Step 212. After that, the socket port corresponding to the name of the newly registered software module is created in Step 214 to perform the software module and the IPC.

Thereafter or if the newly registered software module is the software module stored in the database 106c in the Step 206, it is further determined whether a newly registered mode is a mode stored in the database in step 208. If not, the command register 106b registers the newly registered mode in the database 106c in Step 216 and then, automatically creates a command for a new mode change in Step 218.

After that or if the newly registered mode is mode stored in the database in step 208, it is determined whether a newly registered command is a command previously stored in the database 106c in Step 210. If not, the command register 106c registers a new command in the database 106c in Step 220. Otherwise, the process ends after step 210.

As described above, in the present invention where the communication equipment is managed using the CLI, a new command or software module can be added without compiling the CLI agent again when a new software module or directory is added.

While the invention has been shown and described with reference to a certain preferred embodiment thereof, it will be understood by those skilled in the art that various changes in form and details may be made therein without departing from the spirit and scope of the invention as defined by the appended claims.

What is claimed is:

1. A device for managing a communication equipment using a CLI (command-line interface) agent, comprising:
a management file storage for receiving and storing a management information defined by a managing unit; and
the CLI agent for parsing the management information from the management file storage to determine whether or not the parsed management information has a newly registered information and storing the newly registered information based on the determination when the communication equipment is initially activated, and for allocating a socket port for a newly registered software module and an IPC (inter process communication).

2. The device of claim 1, wherein the CLI agent comprises:
a parser for parsing the management information stored in the management file storage; and
a command register for determining whether or not the parsed management information has a newly registered management information and storing the newly registered management information in a database if the parsed management information is the newly registered management information based on the determination.

3. The device of claim 1, wherein the management information stored in the management file storage is in a string format.

4. The device of claim 1, wherein the management information defined by the managing unit has a software module, a mode, a command, a help, /and an execution function that are executed in the communication equipment and stored in a string format.

5. The device of claim 2, wherein the command register is configured to register the newly registered management information in a global structure stored in the database if the parsed management information has the newly registered management information,

6. A method for managing a communication equipment using a CLI (command-line interface) agent, the method comprising the steps of:
storing a management information for managing the communication equipment by a managing unit;
parsing, by a command register, the management information when the communication equipment is initially activated and determining whether or not the parsed management information has a newly registered management information; and
storing the newly registered management information in a database by the command register based on the determination.

7. The method of claim 6, wherein the management information has a software module, a mode, a command, and a help that are executed in the communication equipment and stored in a string format.

8. The method of claim 7, further allocating a socket port for the newly registered software module and an IPC (inter process communication) if the parsed management information has a newly registered software module.

9. The method of claim 6, wherein the step of parsing the stored management information comprises extracting and sorting only necessary management information from the stored management information.

10. A method for managing a communication equipment using a CLI (command-line interface) agent, the method comprising the steps of:
storing a management information for managing the communication equipment 100 in a string format via a console;
parsing the stored management information;
determining whether or not the parsed management information has a newly registered management information, and if so, it is further determined whether or not the newly registered management information is a software module stored in the database;
determining whether a newly registered mode is a mode stored in the database; and
if the newly registered mode is the mode stored in the database, determining whether the newly registered command is a command previously stored in the database, and if not, registering a new command in the database.

11. The method of claim 10, wherein, if it is determined that the newly registered software module is not the software module stored in the database, registering a name of the newly registered software module in the database; and allocating a socket port corresponding to the name of the newly registered software module.

12. The method of claim 10, wherein if the newly registered mode is the mode stored in the database, registering the newly registered mode in the database; and creating a command for a new mode change.

13. The method of claim 10, wherein the step of parsing the stored management information comprises extracting and sorting only necessary management information from the stored management information.

14. The method of claim 10, wherein the management information has a software module, a mode, a command, and a help that are executed in the communication equipment.
